(19) United States
(12) Patent Application Publication
(10) Pub. No.: US 2008/0101642 A1
(43) Pub. Date: May 1, 2008

(54) Earphone Adaptor

(75) Inventor: Takanao Senda, Kanagawa (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 11/718,685

(22) PCT Filed: Oct. 28, 2005
(86) PCT No.: PCT/JP05/19869

§ 371 Date: May 4, 2007

(30) Foreign Application Priority Data
Nov. 5, 2004 (JP) 2004-321685

(51) Int. Cl. H04R 25/00

(52) U.S. Cl. 381/370

(57) ABSTRACT

An earphone adaptor 6 includes an earphone adaptor body 7 having a jack 12, into which an earphone plug 4 of a pair of earphones 3 is plugged, and a plug 14, which can be plugged into an earphone jack 2 in a TV set 1, and a securing mechanism 8 securing the earphone adaptor body 7 to the TV set 1 in a state wherein the plug 14 is plugged into the earphone jack 2 of the TV set 1. This permits prevention of sudden output of sound from the loudspeakers of the TV set 1 due to the withdrawal of the earphone plug 4.

### TECHNICAL FIELD

The present invention relates to earphone adaptors and, more specifically, to an earphone adaptor used when attaching earphones to an audio device such as a television (hereinafter referred to as “TV”) set.

### BACKGROUND ART

It is common for viewers to view a TV program while allowing sound output to be produced by the loudspeakers of the TV set. However, in many situations it is not appropriate to allow sound output to be produced by the loudspeakers of a TV set.

In a typical household, allowing sound output to be produced by the loudspeakers of a TV set late at night or in the early hours of the morning naturally will disturb one's neighbors. Moreover, it might be inappropriate to allow sound output to be produced by the loudspeakers of a TV set in a hotel or hospital, etc.

Thus, when allowing sound output to be produced by the loudspeakers of a TV set is not appropriate, the viewer plugs an earphone plug into an earphone jack of the TV set and enjoys the sound of the TV program through the earphones. Because sound output from the loudspeakers of a TV set normally is adapted to stop when an earphone plug is plugged into the earphone jack of the TV set, one's neighbors and patients in the same room are not disturbed.

However, the viewing location used when viewing TV programs is typically several meters away from the screen of a TV set and when an earphone cord gets caught on a person or object or when viewers change their posture, the earphone plug may be withdrawn from the earphone jack of the TV set and sound suddenly may be emitted from loudspeakers of the TV set. One usually listens to the sound of a TV set through earphones when sound output from the loudspeakers of the TV set should not be produced, and neighbors and patients in the same room may be startled if sound is suddenly emitted from the loudspeakers of the TV set. In particular, when patients are viewing a TV program in a shared hospital room, this may seriously affect the patients present in the same room.

To solve the problem, a technology has been proposed, in which a TV set is equipped with circuitry for detecting the withdrawal of an earphone plug from the earphone jack of a TV set and automatically stopping sound output from the loudspeakers of the TV set (by setting it to 0) (e.g. see Patent document 1).

Moreover, in another approach used in hospital TV sets etc., the loudspeaker line is severed to prevent such sound leaks from the loudspeakers of a TV set.

It should be noted that various headphone plug conversion adaptors have been proposed and, in particular, in order to prevent headphones from shifting and falling off the wearer's head under the weight of an adaptor, a plug conversion adaptor for headphones has been proposed which is equipped with a mini-plug that can be plugged into the audio output jack of a portable tape recorder etc., a jack for standard plugs, which is connected to the mini plug via an electrical cord of a prescribed length and into which a standard headphone plug is plugged, and a clip, which is provided in the jack for standard plugs and which can be fastened to the headphone wearer's garment or belt (e.g. see Patent document 2).
[Patent Document 1] JP H2-13395U.
[Patent Document 2] JP H1-15089Y.

### DISCLOSURE OF INVENTION

### Problem to be Solved by the Invention

However, besides the fact that adding new functionality to the circuitry of a TV set, as was done in the Patent document 1 etc., increases the cost of the product, providing such functionality in all audio devices with earphone jacks, including audio devices other than TV sets, generally will be impossible.

In addition, a TV set with a severed loudspeaker line loses commercial value and its subsequent resale etc., becomes impossible.

Moreover, the problem cannot be resolved because in the headphone plug conversion adaptors of the above-described configuration the mini-plug is plugged into the audio output jack of a portable tape recorder etc. “as is” and when an external force acts on the electrical cord connecting the mini plug and the jack for standard plugs, the mini-plug is withdrawn from the audio output jack of the portable tape recorder etc., resulting in sound being suddenly generated from the loudspeakers of the portable tape recorder, etc.

The present invention was made in order to solve the above-described problems of the prior art and its object is to provide an earphone adaptor that can prevent sound output from being suddenly produced from loudspeakers when an earphone plug is withdrawn from the earphone jack of an audio device provided with loudspeakers, such as a TV set, without adding new functionality to the circuitry of the TV set or another audio device and without reducing the commercial value of the TV set or another audio device.

### Means for Solving Problem

To attain the object, the earphone adaptor of the present invention is configured to include an earphone adaptor body provided with a jack, into which the earphone plug of the earphones is plugged, and a plug that can be plugged into an earphone jack in an audio device, as well as a securing mechanism securing the earphone adaptor body to the audio device in a state in which the plug is plugged into the earphone jack of the audio device.

Because in accordance with the configuration of this earphone adaptor the earphone adaptor body can be secured to the audio device in a state wherein the plug is plugged into the earphone jack of the audio device, even if the earphone plug is pulled on for one reason or another, such as the headphone cord getting caught on a person or object or viewers changing their posture, the plug of the earphone adaptor body will not be withdrawn from the earphone jack of the audio device even if the earphone plug falls out of the jack of the earphone adaptor body. In this manner, even if the earphone plug falls out of the jack of the earphone adaptor body, the plug of the earphone adaptor body will not be withdrawn from the earphone jack of the audio device and sound output from the loudspeakers of the audio device will still remain inactive. Therefore, sudden output of sound from the loudspeakers of audio device due to the withdrawal of an earphone plug can be prevented.

In the configuration of the earphone adaptor of the present inventive, the earphone adaptor body preferably is provided with a jack carrier supporting the jack, a plug carrier supporting the plug, an electrical cord connecting the jack carrier and the plug carrier, and the securing mechanism preferably is constituted by a flexible coupling member coupling the electrical cord to the audio device. According to this preferred example, the jack carrier is pulled towards the audio device through the medium of the electrical cord and coupling member and, as a result, forces applied to the plug carrier can be reduced if the earphone plug is pulled at for one reason or another, such as when the earphone cord gets caught on a person or object or viewers change their posture. Therefore, since the plug of the plug carrier of the earphone adaptor body will not be withdrawn from the earphone jack of the audio device even if the earphone plug falls out of the jack of the earphone adaptor body, sudden output of sound from the loudspeakers of the audio device due to the withdrawal of the earphone plug can be prevented. Moreover, in such a case, it is preferable for the coupling member to have an annular detent portion. According to this preferred example, the coupling member can be threadedly secured to the audio device using existing screws attached at the rear of the audio device. Moreover, in such a case, it is preferable for the coupling member to have a hook portion. According to this preferred example, the coupling member can be secured to the audio device by engaging it in a slit provided at the rear of the audio device. In addition, in such a case, the coupling member preferably has an engaging portion that is capable of locking the coupling member and is provided midway therealong. According to this preferred example, the coupling member can be secured to the audio device by locking the coupling member with the engaging portion in a state in which it is engaged with an antenna terminal etc. provided at the rear of the audio device. In this case, the coupling member preferably further has a structure of multiple coupled substantially spherical locking members, and the engaging portion has a through hole, which allows the locking members to pass therethrough, and a withdrawal-preventing hole, which prevents the withdrawal of the locking members and is provided in communication with the through-hole.

Moreover, in the configuration of the earphone adaptor of the present inventive, the earphone adaptor body preferably is equipped with a jack/plug carrier that integrally supports the jack and plug. Moreover, in such a case, the jack and plug are preferably supported by the jack/plug carrier in a state in which their central axes are offset relative to one another. According to this preferred example, when the earphone adaptor body is adhesively secured to an audio device using an adhesive layer, the surface area over which the adhesive layer is formed on the plug end of the jack/plug carrier can be increased and, therefore, the bonding strength between the jack/plug carrier and the audio device can be enhanced. Moreover, the proximal end portion of the plug and the distal portion of the jack inside the jack/plug carrier can be made to overlap in the longitudinal direction of the jack/plug carrier, and, therefore, the length of the jack/plug carrier in the longitudinal direction can be shortened.

Moreover, in the configuration of the earphone adaptor of the present inventive, the securing mechanism preferably has a threaded bore permitting threaded securement to an audio device. Moreover, in the configuration of the earphone adaptor of the present inventive, the securing mechanism preferably has an adhesive layer permitting adhesive securement to an audio device. According to these preferred examples, the earphone adaptor body can be secured reliably to an audio device.

Moreover, in the configuration of the earphone adaptor of the present inventive, the securing mechanism preferably has an arm that is urged in the direction of the earphone adaptor body and a support portion supporting the arm. According to this preferred example, the attachment of the earphone adaptor body to the audio device and its detachment therefrom are facilitated. Moreover, in such a case, the arm and/or support portion preferably have an adjustable-length slide structure. According to this preferred example, the earphone adaptor can be utilized with audio devices of various sizes. Moreover, when the earphone adaptor is stored, compact storage can be accomplished.

Moreover, in the configuration of the earphone adaptor of the present inventive, the securing mechanism preferably has an adjustable-height clamp portion and a support portion supporting the clamp portion. According to this preferred example, the attachment of the earphone adaptor body to the audio device and its detachment therefrom are facilitated. Moreover, in such a case, the clamp and/or support portion preferably have an adjustable-length slide structure. According to this preferred example, said earphone adaptor can be utilized with audio device of various sizes. Moreover, when the earphone adaptor is stored, compact storage can be accomplished.

Moreover, in the configuration of the earphone adaptor of the present inventive, the jack preferably is provided so as to be rotatable within a two-dimensional plane seen from the front of the earphone jack of the audio device when the earphone adaptor body is secured to the audio device. According to this preferred example, the jack into which the earphone plug is plugged can be made to follow flexibly changes in the posture of the user of the earphones (viewer), and makes it possible to provide the user of the earphones with an enjoyable wearing experience. Moreover, prevention of earphone plug withdrawal can be implemented as well.

Moreover, in the configuration of the earphone adaptor of the present inventive, the jack preferably is provided so as to be rotatable within a plane disposed at right angles to the two-dimensional plane seen from the front of the earphone jack of the audio device when the earphone adaptor body is secured to the audio device. According to this preferred example, the jack, into which the earphone plug is plugged, can be made to flexibly follow changes in the posture of the user of the earphones (viewer), and makes it possible to provide the user of the earphones with an enjoyable wearing experience.

Moreover, in the configuration of the earphone adaptor of the present inventive, the earphone adaptor body preferably is provided so as to be releasably attachable to the securing mechanism via connecting portions. According to this preferred example, the following effects are obtained. Namely, as a rule, sound output can be obtained from the loudspeakers of an audio device by detaching the earphone adaptor body from the securing mechanism. On the other hand, when one wishes to stop sound output from the loudspeakers of the audio device late at night or in the early hours of the morning, one can listen to the sound of TV programs etc. through the earphones by attaching the earphone adaptor body to the securing mechanism secured to the audio device and then plugging the earphone plug of the earphones into the jack of the earphone adaptor body. Moreover, in such a case, the connecting portion is constituted by a first connecting portion provided in the earphone adaptor body and a second connecting portion provided in the securing mechanism, and the earphone adaptor body preferably is attached to the securing mechanism by connecting the first connecting portion and second connecting portion to each other.

The earphone adaptor of the present invention can produce its effects in a more efficient manner when there is provided one earphone jack and one earphone plug. This is due to the fact that when a separate jack for transmitting actuation signals other than audio signals is juxtaposed adjacent to the earphone jack, and they are both connected to a single earphone cord, withdrawal of the earphone plug is rendered more difficult than when the audio device only has a single earphone jack.

### EFFECTS OF THE INVENTION

The present invention makes it possible to prevent sound output from suddenly being produced from the loudspeakers when an earphone plug is withdrawn from the earphone jack of an audio device provided with speakers without adding new functionality to the circuitry of the audio device, and, moreover, without reducing the commercial value of the audio device.

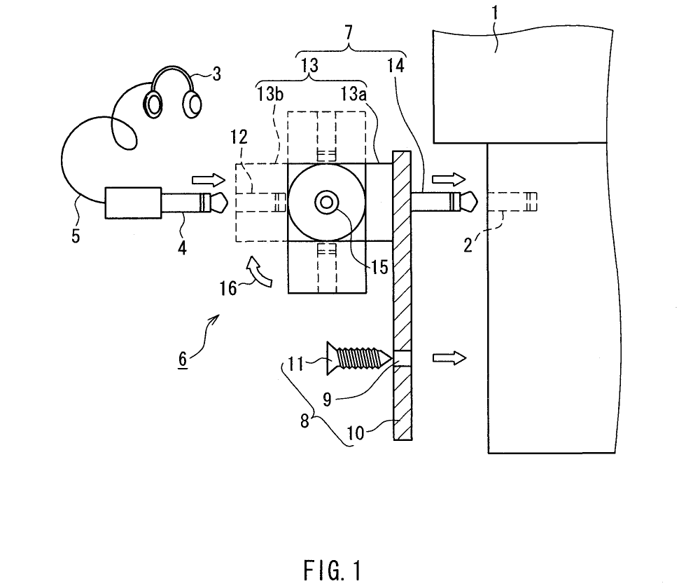

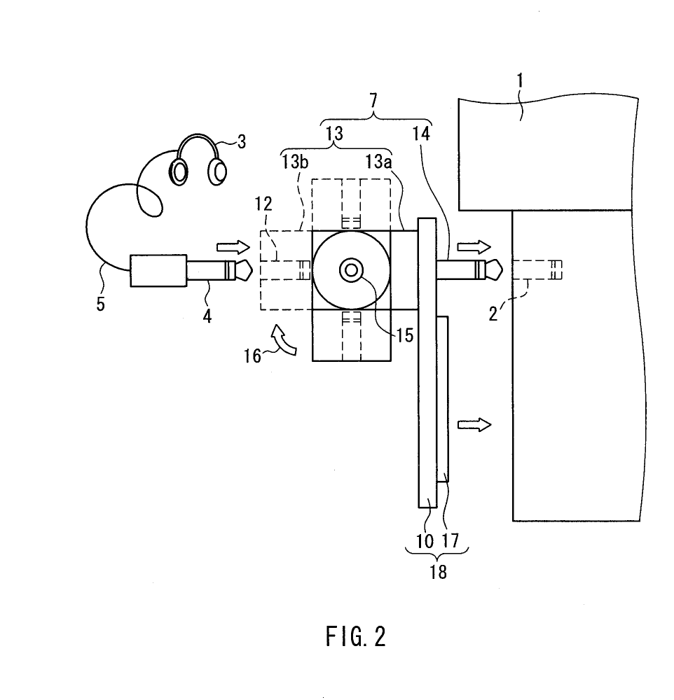

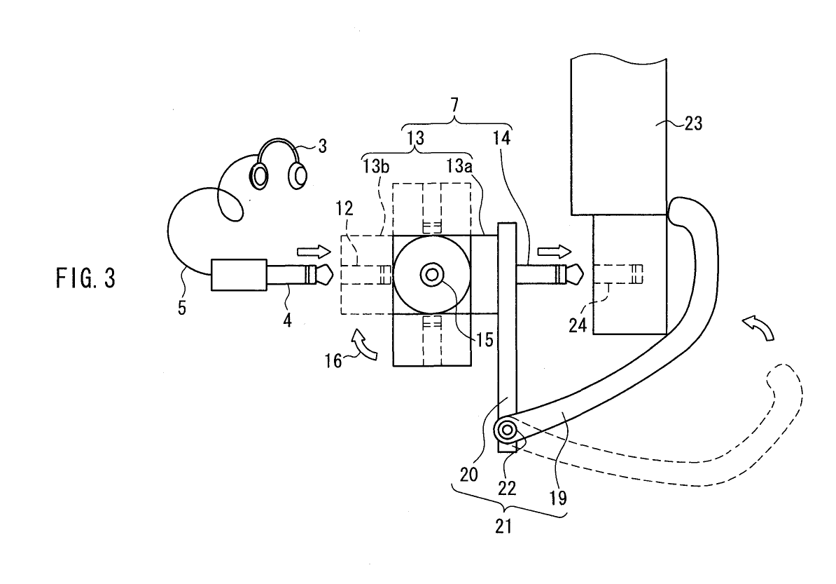

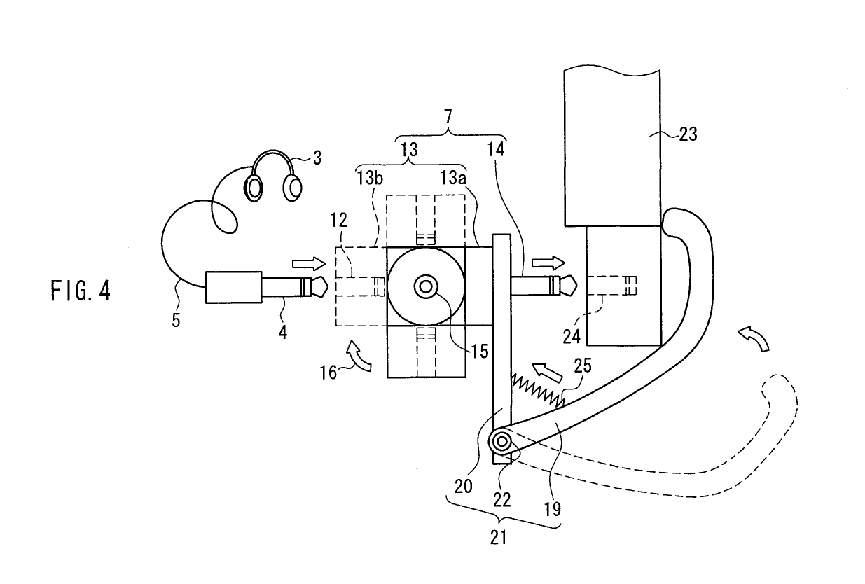

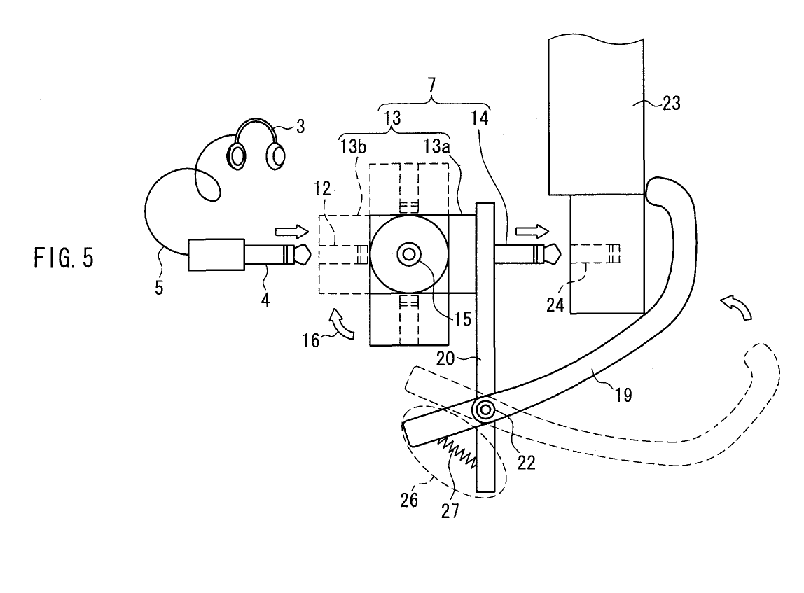

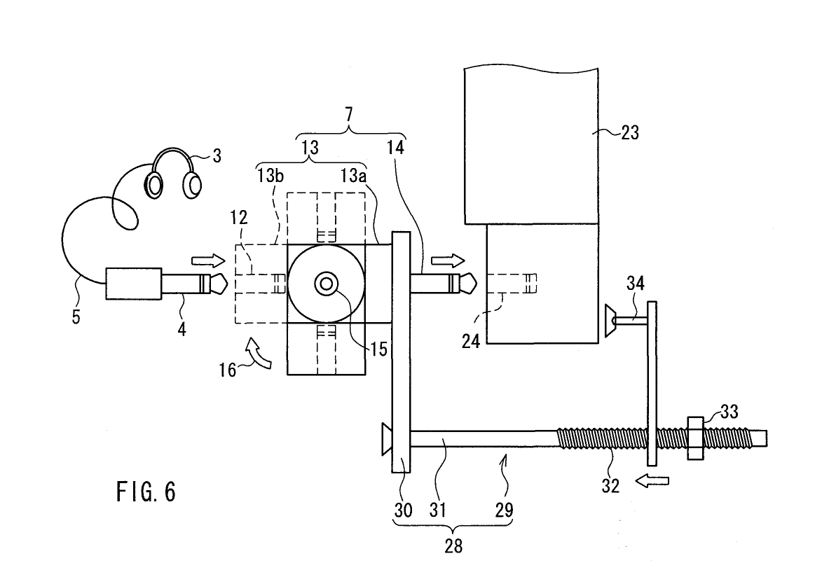

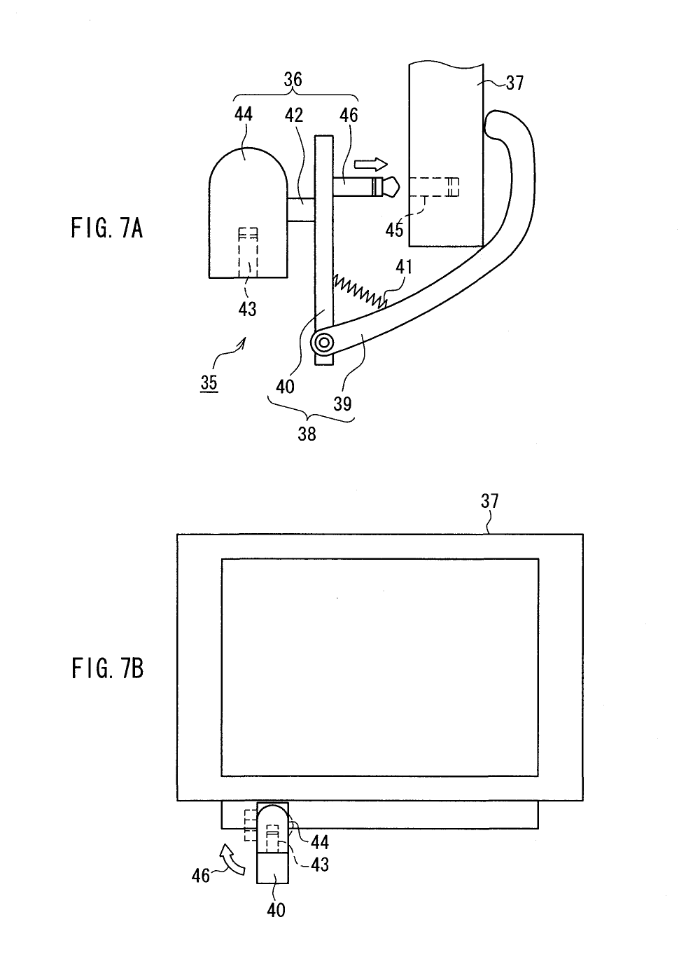

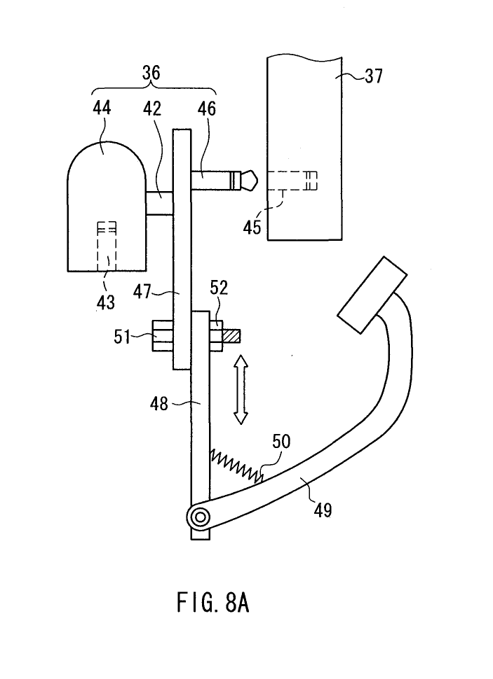

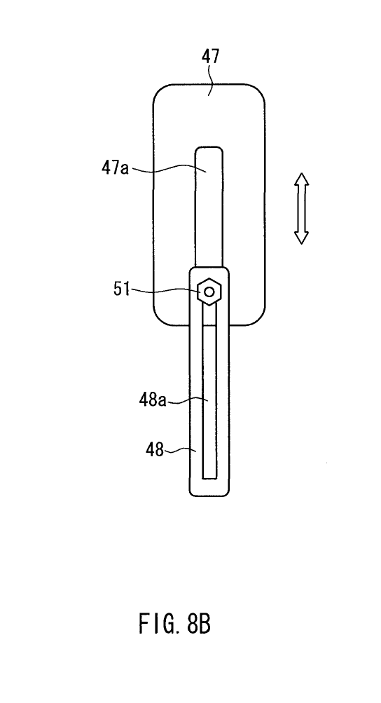

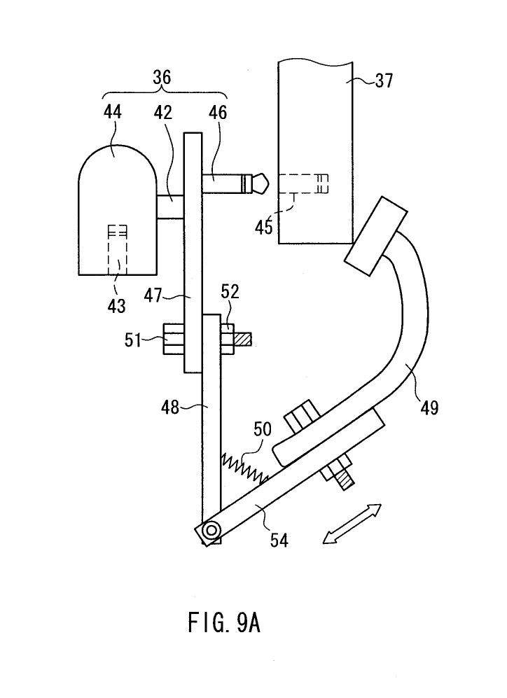

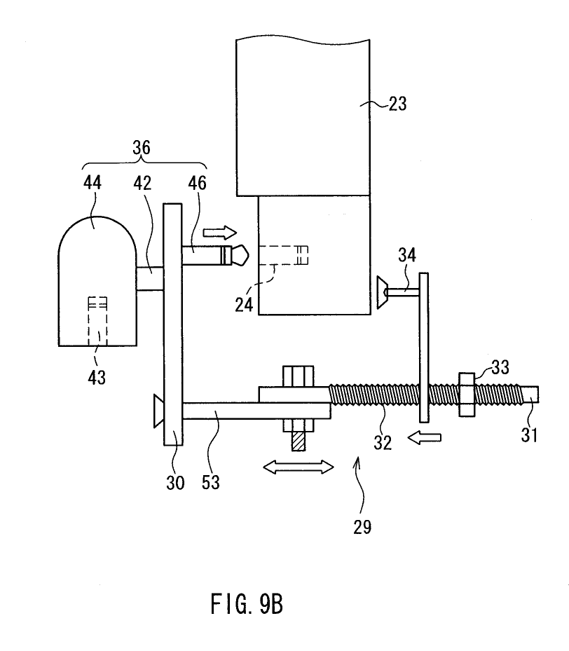

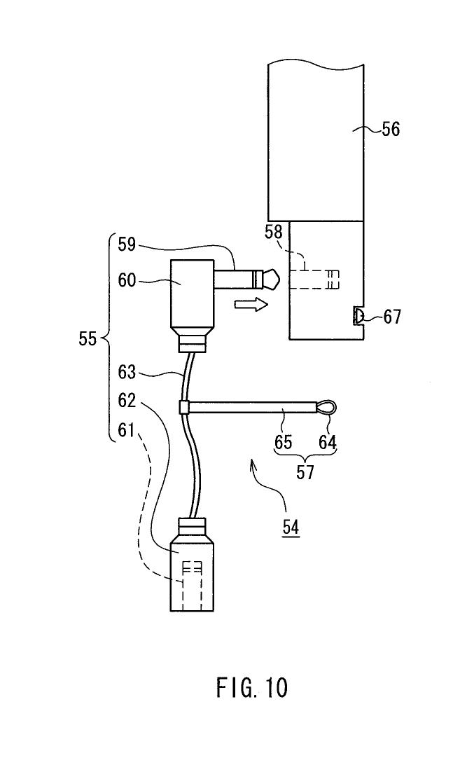

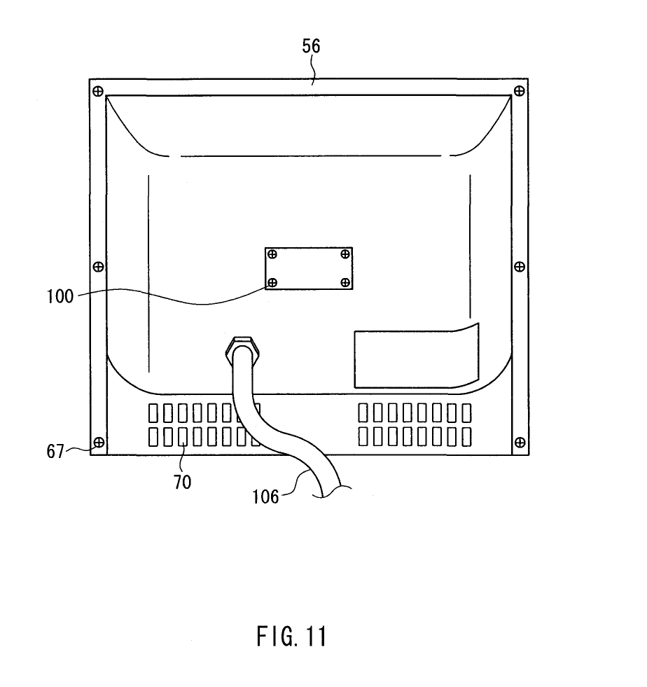

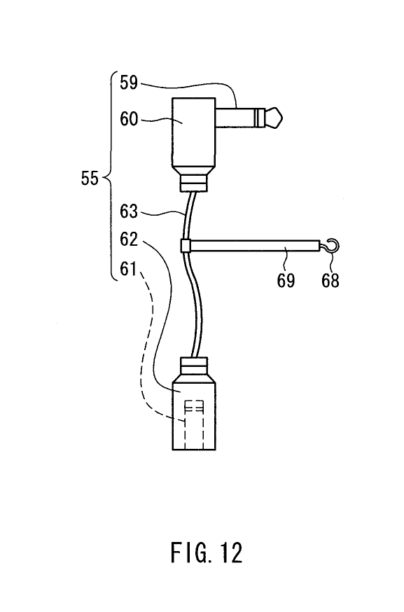

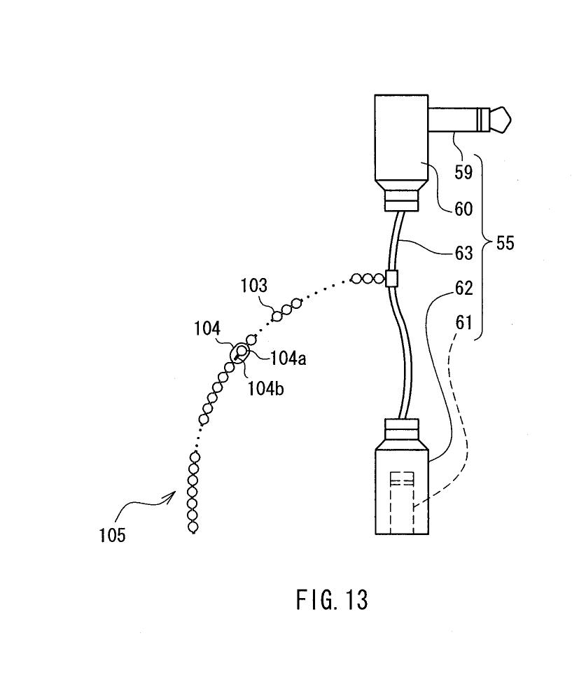

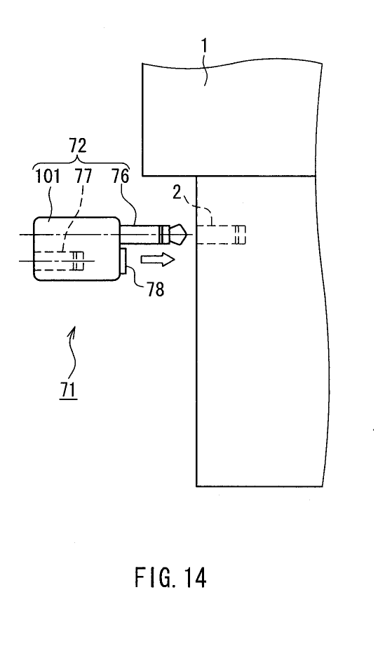

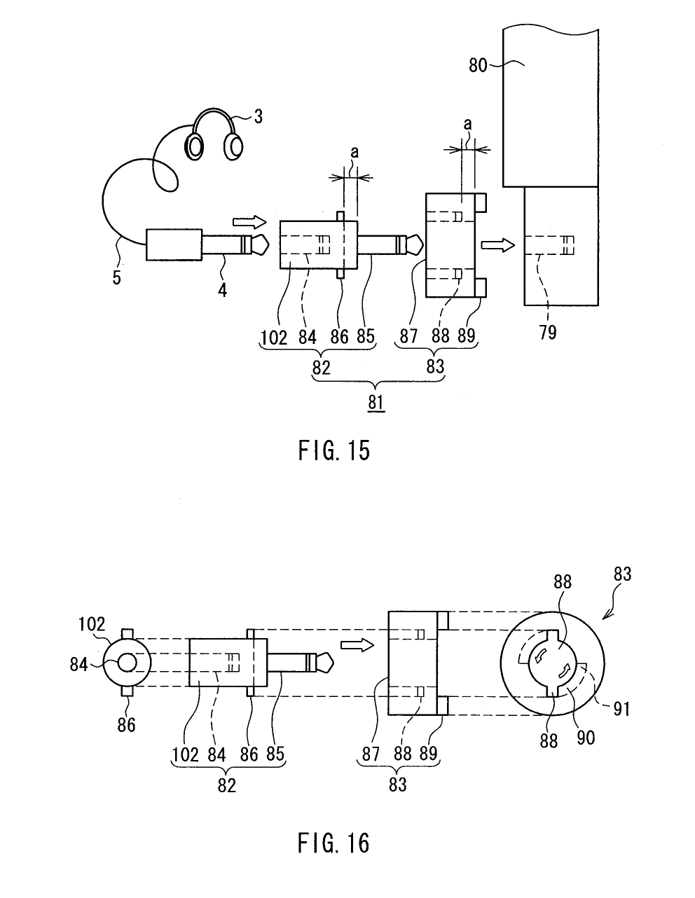

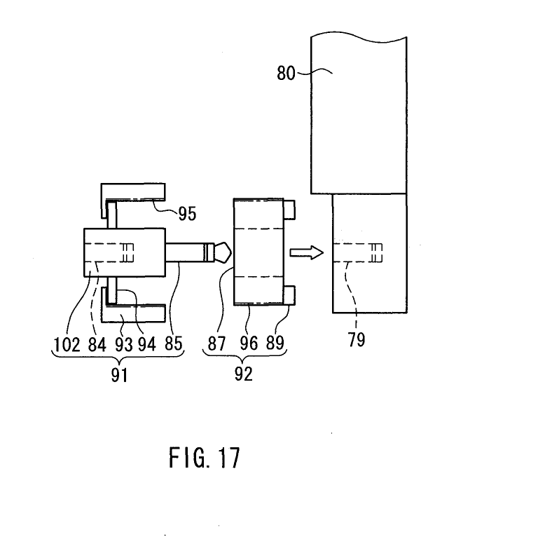

### BRIEF DESCRIPTION OF DRAWINGS

[FIG. 1] A side view illustrating the relationship between a TV set and earphones and an exemplary earphone adaptor (with a securing mechanism based on threaded securement) in Embodiment 1 of the present invention.

[FIG. 2] A side view illustrating the relationship between a TV set and earphones and another exemplary earphone adaptor (with a securing mechanism based on adhesive securement) in Embodiment 1 of the present invention.

[FIG. 3] A side view illustrating the relationship between a TV set and earphones and yet another exemplary earphone adaptor (with a securing mechanism based on the use of an arm's urging force provided by a flat spiral spring) in Embodiment 1 of the present invention.

[FIG. 4] A side view illustrating the relationship between a TV set and earphones and yet another exemplary earphone adaptor (with a securing mechanism based on the use of an arm's urging force provided by a coil spring) in Embodiment 1 of the present invention.

[FIG. 5] A side view illustrating the relationship between a TV set and earphones and still another exemplary earphone adaptor (with the securing mechanism based on the use of an arm's urging force provided by a clothespin-like structure) in Embodiment 1 of the present invention.

[FIG. 6] A side view illustrating the relationship between a TV set and earphones and yet another exemplary earphone adaptor (with the securing mechanism based on a clamping mechanism) in Embodiment 1 of the present invention.

[FIG. 7A] A side view illustrating the relationship between a TV set and an exemplary earphone adaptor in Embodiment 2 of the present invention.

[FIG. 7B] A front view illustrating a state, in which an earphone adaptor body is secured to a TV set in Embodiment 2 of the present invention.

[FIG. 8A] A side view illustrating the relationship between a TV set and an exemplary earphone adaptor in Embodiment 3 of the present invention.

[FIG. 8B] A front view illustrating the configuration of the securing mechanism of the earphone adaptor without an arm, as used in Embodiment 3 of the present invention.

[FIG. 9A] A side view illustrating the relationship between a TV set and another exemplary earphone adaptor in Embodiment 3 of the present invention.

[FIG. 9B] A side view illustrating the relationship between a TV set and yet another exemplary earphone adaptor in Embodiment 3 of the present invention.

[FIG. 10] A side view illustrating the relationship between a TV set and an exemplary earphone adaptor in Embodiment 4 of the present invention.

[FIG. 11] A schematic rear view of a TV set, to which the earphone adaptor body of Embodiment 4 of the present invention is to be secured.

[FIG. 12] A side view illustrating another exemplary earphone adaptor in Embodiment 4 of the present invention.

[FIG. 13] A side view illustrating yet another exemplary earphone adaptor in Embodiment 4 of the present invention.

[FIG. 14] A side view illustrating the relationship between a TV set and an exemplary earphone adaptor in Embodiment 5 of the present invention.

[FIG. 15] A side view illustrating the relationship between a TV set and earphones and an exemplary earphone adaptor in Embodiment 6 of the present invention.

[FIG. 16] A diagram illustrating the relationship between a securing mechanism and an earphone adaptor body in Embodiment 6 of the present invention.

[FIG. 17] A side view illustrating the relationship between a TV set and another exemplary earphone adaptor in Embodiment 6 of the present invention.

### BEST MODE FOR CARRYING OUT THE INVENTION

Below, the present invention is particularly described with reference to embodiments.

### Embodiment 1

FIG. 1 is a side view illustrating the relationship between a TV set and earphones and an exemplary earphone adaptor in Embodiment 1 of the present invention.

In FIG. 1, the numeral 1 designates a television (TV) set, and the numeral 2 designates an earphone jack provided in the TV set 1. The numeral 3 designates earphones, and the numeral 4 designates an earphone plug provided in the earphones 3. The earphones 3 and earphone plug 4 are connected via an earphone cord 5.

As shown in FIG. 1, the earphone adaptor 6 of the present embodiment comprises an earphone adaptor body 7 and a securing mechanism 8 securing the earphone adaptor body 7 to the TV set 1. The securing mechanism 8 is made up of a supporting substrate 10 having a threaded bore 9 formed therein and a screw 11 securing the supporting substrate 10 to the TV set 1. The earphone adaptor body 7 is made up of a jack 12, into which the earphone plug 4 of the earphones 3 is plugged, a plug 14 that can be plugged into the earphone jack 2 of the TV set 1, and a jack/plug carrier 13 integrally supporting the jack 12 and plug 14, with the earphone adaptor body 7 attached to the supporting substrate 10 in a state in which the plug 14 protrudes from the surface of the rear side (the side facing the TV set 1) of the supporting substrate 10. Additionally, the earphone adaptor body 7 is secured to the TV set 1 by threadedly securing the supporting substrate 10 to the TV set 1 in a state in which the plug 14 is plugged into the earphone jack 2 of the TV set 1.

Moreover, in the earphone adaptor 6 of the present embodiment, the jack/plug carrier 13 is made up of a first carrier 13a provided normally to the surface of the front side of the supporting substrate 10, and a second carrier 13b, which is rotatably coupled to the first carrier 13a via a rotary shaft 15 and has a jack 12. Namely, the second carrier 13b, which has a jack 12, into which the earphone plug 4 of the earphones 3 is plugged, is adapted to be rotatable through 180 degrees within a two-dimensional plane (see arrow 16 in FIG. 1), as viewed from the side of the earphone adaptor 6. It should be noted that in such a case the jack 12 and plug 14 are electrically connected via a flexible wire.

Thus, the configuration of the earphone adaptor 6 of the present embodiment makes it possible to secure the earphone adaptor body 7 to the TV set 1 in a state in which the plug 14 is plugged into the earphone jack 2 of the TV set 1, such that, even if the earphone plug 4 is pulled at for one reason or another, such as when the earphone cord 5 gets caught on a person or an object, or the viewer changes their posture, etc., the plug 14 of the earphone adaptor body 7 will not be withdrawn from the earphone jack 2 of the TV set 1 even if the earphone plug 4 falls out of the jack 12 of the earphone adaptor body 7. Because the plug 14 of the earphone adaptor body 7 will not be withdrawn from the earphone jack 2 of the TV set 1 even if the earphone plug 4 falls out of the jack 12 of the earphone adaptor body 7, sound output from the loudspeakers, not shown, with which the TV set 1 is provided, will remain inactive. Therefore, sudden output of sound from the loudspeakers of the TV set 1 due to the withdrawal of the earphone plug 4 can be prevented, and therefore, viewers can enjoy late-night programming without worry. Moreover, patients sharing the same hospital room can enjoy TV programming without apprehension of sudden sound emissions and bothering other patients.

Moreover, in the earphone adaptor 6 of the present embodiment, the standalone configuration used for the earphone adaptor 6 permits securement of the earphone adaptor body 7 to the TV set 1. Therefore, even if there are no objects suitable for engagement, such as protrusions, etc., on the TV 1, the earphone adaptor body 7 can be secured to the TV set 1. In other words, according to the present embodiment, a highly versatile earphone adaptor can be provided.

Moreover, the configuration of the earphone adaptor 6 of the present embodiment makes it possible to prevent sound leaks from the loudspeakers of the TV set 1 while the earphone plug 4 easily can be withdrawn (with the jack 12 of the earphone adaptor body 7 being oriented in the same direction as the earphone jack 2 of the TV set 1), so that even if the earphone cord 5 gets caught on a person's foot, the earphone plug 4 immediately falls out and the person can be prevented from tripping.

Furthermore, the configuration of the earphone adaptor 6 of the present embodiment makes it possible to protect the earphone jack 2 of the TV set 1. Namely, if the earphone plug 4 were directly plugged into the earphone jack 2 of the TV set 1 and, for one reason or another, such as if the earphone cord 5 got caught on a person, or the user of the earphones 3 (viewer) changed their viewing posture, etc., a force would be exerted on the earphone plug 4 in a direction other than the longitudinal direction, as viewed from the front of the earphone jack 2 of the TV set 1, the earphone plug 4 would bend, the earphone jack 2 of the TV set 1 would be damaged, and the earphones 3 and TV set 1 would break down. However, if the earphone adaptor 6 of the present embodiment is used, the likelihood of the TV set 1 failing is rather low even if the earphones 3 and earphone adaptor 6 do fail. Taking into account the price difference between the TV set 1 and the earphones 3 and earphone adaptor 6, the advantages offered by reducing the likelihood of failure of the TV set 1 are quite significant.

Moreover, because in the configuration of the earphone adaptor 6 of the present embodiment the jack/plug carrier 13 is constituted by a first carrier 13a provided normally to the surface of the front side of the supporting substrate 10 and a second carrier 13b, which is rotatably coupled to the first carrier 13a via a rotary shaft 15 and has a jack 12, the jack 12, into which the earphone plug 4 is plugged, can be made to follow flexibly changes in the posture of the user of the earphones 3 (viewer) and makes it possible to provide the user of the earphones 3 with an enjoyable wearing experience.

It should be noted that although in the present embodiment the security mechanism is explained by citing an example of a securing mechanism 8 constituted by a supporting substrate 10 having a threaded bore 9 formed therein and a screw 11 securing the supporting substrate 10 to the TV set 1, the securing mechanism is not limited to such a configuration and may be any configuration permitting the earphone adaptor body 7 to be securable to the TV set 1 in a state in which the plug 14 of the earphone adaptor body 7 is plugged into the earphone jack 2 of the TV set 1.

For instance, as shown in FIG. 2, a securing mechanism 18 is constituted by a supporting substrate 10 and a double-sided tape 17, which is bonded to the surface of the rear side (the side facing the TV set 1) of the supporting substrate 10 and which is capable of adhesively securing the supporting substrate 10 to the TV set 1, such that the earphone adaptor body 7 may be secured to the TV set 1 using the adhesive strength of the double-sided tape 17. If the securing mechanism 18 of this configuration is used, undesirable effects with respect to the TV set 1, such as the need to form threaded bores, etc. can be kept to a minimum in comparison with using the above-described screw 11. Moreover, the attachment and detachment of the earphone adaptor body 7 are also facilitated. Therefore, there is nothing that would create obstacles impeding the resale etc. of the TV set 1. In such a case, so long as the supporting substrate 10 can be secured to the TV set 1, in addition to the double-sided tape, one could also use adhesives and hook-and-loop fasteners.

Moreover, as shown in FIG. 3, a securing mechanism 21 may be constituted by an arm 19 whose distal portion is urged in the direction of the earphone adaptor body 7, and a supporting substrate 20 serving as a support portion, to which the earphone adaptor body 7 is attached and the proximal end portion of the arm 19 is rotatably coupled, such that the earphone adaptor body 7 can be secured to a TV set 23 using the urging force of the distal portion of the arm 19. Although details are not shown in the figure, the urging of the distal portion of the arm 19 in the direction of the earphone adaptor body 7, for instance, can be realized by embedding a flat spiral spring into a rotary shaft 22 coupling the supporting substrate 20 to the arm 19. Moreover, as shown in FIG. 4, the urging of the distal portion of the arm 19 in the direction of the earphone adaptor body 7 also can be accomplished by interposing a coil spring 25 between the supporting substrate 20 and arm 19. Furthermore, as shown in FIG. 5, the supporting substrate 20 and the proximal end of the arm 19 can be extended in a direction opposite the distal portion of the arm 19 relative to the rotary shaft 22 and this portion can be used as a handle 26. In the handle 26, a coil spring 27 is interposed between the supporting substrate 20 and arm 19, with both of them urged in respectively opposite directions. As a result, the distal portion of the arm 19 is urged in the direction of the earphone adaptor body 7. In this manner, the use of the so-called clothespin-like structure as the securing mechanism permits easy attachment and detachment of the earphone adaptor body 7 to/from the TV set 23. In the securing mechanism of the above configuration, elastic members preferably are used for the contacting portions of the supporting substrate 20 and arm 19 with the TV set 23. This makes it possible to prevent damage to the TV set 23. Moreover, the anti-slip effect produced between the elastic members and the frame of the TV set 23 can prevent the earphone adaptor body 7 from slipping out of securement to the TV set 23. It should be noted that in FIG. 3 to FIG. 5, the numeral 24 designates an earphone jack provided in the TV set 23.

Moreover, as shown in FIG. 6, a securing mechanism 28 (clamping mechanism) may be constituted by an adjustable-height clamp portion 29 and a supporting substrate 30 serving as a support portion, to which the earphone adaptor body 7 is attached and on which the clamp portion 29 is supported. The clamp portion 29 is constituted by a shaft 31 which, along with having one end thereof supported by the supporting substrate 30, has a screw thread 32 cut therein, a nut 33 with a female thread cut therein and threaded onto the screw thread 32 of the shaft 31, and a pressure element 34 through which the shaft 31 passes and which is positioned between the supporting substrate 30 and the nut 33. In this case, the pressure element 34 can be moved in the direction of the supporting substrate 30 by rotating the nut 33. The earphone adaptor body 7 is then secured to the TV set 23 in a state wherein the plug 14 is plugged into the earphone jack 24 of the TV set 23 by applying pressure to the rear face of the TV set 23 with the pressure element 34 by rotating the nut 33. In this manner, the use of the securing mechanism 28 provided with the clamp portion 29 as the securing mechanism permits easy attachment and detachment of the earphone adaptor body 7 to/from the TV set 23. In this case, elastic members preferably are used for the contacting portions of the supporting substrate 30 and pressure element 34 with TV set 23. This makes it possible to prevent damage to the TV set 23. Moreover, the anti-slip effect produced between the elastic members and the frame of the TV set 23 makes it possible to prevent the earphone adaptor body 7 from slipping out of securement to the TV set 23.

Thus, when a clamp shape or clothespin-like shape is imparted to the securing mechanism, the earphone adaptor of the present invention can be used with thin-shaped TV sets, in particular. If there is a protrusion, the earphone adaptor body 7 can be secured even to a conventional cathode ray tube TV set by engaging the pressure element 34 of the clamp portion 29 or arm 19 therewith, and if this is a thin-shaped TV set (LCD (Liquid Crystal Display), PDP (Plasma Display Panel), organic EL (Electro-Luminescence), FED (Field Emission Display), etc.), which currently has become popular, then the earphone adaptor body 7 can be secured even more reliably because the pressure element 34 of the clamp portion 29 or arm 19 can be engaged with the TV set itself.

When the earphone adaptor body 7 is attached to the TV set 23, it may be engaged therewith by rotating the arm 19 or the pressure element 34 of the clamp portion 29 towards the rear face of the TV set 23 from above, below, or right or left side of the TV set 23. Because the position of the earphone jack 24 in the TV set 23 may vary depending on the manufacturer, the length of the supporting substrates 20 and 30 and arm 19, as well as the clamp portion 29, preferably have a certain amount of margin built into it.

For instance, the length of the supporting substrates 20 and 30 can be determined taking into account the fact that the earphone jack 24 is typically provided in the portion close to the edge of the TV set 23. Moreover, generally speaking, because the depth of a thin-shaped TV set is in most cases between approximately 10 cm and approximately 30 cm, the securing mechanism 21 may be designed such that the distance between the distal portion of the arm 19 and the supporting substrate 20 is 30 cm or so when the arm 19 is fully opened. Moreover, although the securing mechanism 28 provided with the clamp portion 29 may be designed such that the distance between the supporting substrate 30 and the pressure element 34 is 30 cm or so, with account taken of the recent trend towards thinner TV sets, where TV sets with a depth of 10 cm or so are expected to become widespread, it may be possible to set these distances to 10 cm or so.

In addition, while this is not shown in the figures, the securing mechanism can be designed to be substantially π-shaped and utilize an elastic member made of rubber etc., and, as a result, the securing mechanism permits urging in the direction of the earphone adaptor body. Because in such a case there is no need to use components such as the clamp portion or rotary shaft rotatably supporting an arm, the configuration of the securing mechanism can be simplified. Accordingly, this provides for a simpler manufacturing process and reduces the cost of earphone adaptor manufacture.

Moreover, without urging in the direction of the earphone adaptor body, the securing mechanism may be designed so as to have a certain length in the longitudinal direction, as viewed from the front of the earphone jack of the TV set, with the TV set placed on this securing mechanism. According to such a configuration, the earphone adaptor body can be secured to the TV set by the TV set's own weight. A more versatile earphone adaptor then can be provided by implementing the earphone adaptor on the basis of such an extremely simple configuration.

Moreover, although in the earphone adaptor body 7 of the present embodiment the jack/plug carrier 13 is made up of the first carrier 13a provided normally to the surface of the front side of the supporting substrate 10 (or 20 or 30) and the second carrier 13b, which is rotatably coupled to the first carrier 13a via the rotary shaft 15 and has the jack 12, with the second carrier 13b being adapted to be rotatable within a two-dimensional plane, as viewed from the side of the earphone adaptor 6, the second carrier may be adapted to be rotatable freely relative to the first carrier using e.g. a pivot bearing. According to this configuration, the jack, into which the earphone plug 4 is plugged, can be made to follow flexibly changes in the posture of the user of the earphones 3 (viewer) and the user of the earphones 3 can have an enjoyable wearing experience.

### Embodiment 2

FIG. 7A is a side view illustrating the relationship between a TV set and an exemplary earphone adaptor in Embodiment 2 of the present invention and FIG. 7B is a front view illustrating a state, in which an earphone adaptor body is secured to a TV set in the present embodiment.

As shown in FIG. 7A, the earphone adaptor 35 used in the present embodiment comprises an earphone adaptor body 36 and a securing mechanism 38 securing the earphone adaptor body 36 to a TV set 37. The securing mechanism 38 is constituted by an arm 39, whose distal portion is urged in the direction of the earphone adaptor body 36, and a supporting substrate 40 serving as a support portion to which the earphone adaptor body 36 is attached and the proximal end portion of the arm 39 is rotatably coupled, such that the earphone adaptor body 36 can be secured to the TV set 37 using the urging force of the distal portion of the arm 39. The urging of the distal portion of the arm 39 in the direction of the earphone adaptor body 36 is realized by interposing a coil spring 41 between the supporting substrate 40 and arm 39. The earphone adaptor body 36 is constituted by a jack carrier 44 supporting the jack 43, which is provided on the surface of the front side of the supporting substrate 40 through the medium of a rotary portion 42 and in which the earphone plug 4 (see FIG. 1) is plugged, and a plug 46, which is provided on the surface of the rear side (facing the TV set 37) of the supporting substrate 40 and can be plugged into the earphone jack 45 of the TV set 37. Although details are not shown in the figure, the rotary portion 42 is formed by rotatably engaging a rotary body constituting a male side and a rotary shaft constituting a female side such that a certain clearance is maintained therebetween. It should be noted that in order to ensure smooth rotational operation of the jack carrier 44, the rotary portion 42 also can be fitted with bearings. With this configuration, the jack carrier 44 can rotate within a two-dimensional plane (in the direction of arrow 46 in FIG. 7B), as viewed from the front of the earphone jack 45 of the TV set 37.

In this manner, due to a configuration that enables rotation of the jack carrier 44 by providing the rotary portion 42 in the earphone adaptor 35, the jack 43, into which the earphone plug 4 is plugged, can be made to follow flexibly changes in the posture of the user (viewer) of the earphones 3 (see FIG. 1) and the user of the earphones 3 can be provided with an enjoyable wearing experience.

It should be noted that in the earphone adaptor 35 of the present embodiment, unlike in the earphone adaptor of the above-described Embodiment 1, no elements are provided that correspond to the rotary shaft 15 of FIG. 1, etc. Therefore, the jack 43, into which the earphone plug 4 is plugged, cannot rotate in a plane disposed at right angles to the two-dimensional plane seen from the front of the earphone jack 45 of the TV set 37. For this reason, the withdrawal of the earphone plug 4 can also be prevented while maintaining the ability of the jack 43, into which the earphone plug 4 is plugged, to follow flexibly changes in the posture of the user of the earphones 3 (viewer).

### Embodiment 3

FIG. 8A is a side view illustrating the relationship between a TV set and an exemplary earphone adaptor in Embodiment 3 of the present invention, and FIG. 8B is a front view illustrating the configuration of the securing mechanism of the earphone adaptor without an arm used in the present embodiment. It should be noted that the same components as the components of the earphone adaptor of the above-described Embodiment 2 are designated by the same numbers, and their detailed explanation is therefore omitted.

In FIG. 8A, the numeral 47 designates a supporting substrate, to which an earphone adaptor body 36 is attached. As shown in FIG. 8A and FIG. 8B, a slide 48 is slidably attached to the supporting substrate 47, and the proximal end portion of an arm 49 is rotatably coupled to the slide 48. A coil spring 50 is interposed between the slide 48 and the arm 49, and as a result, the distal portion of the arm 49 is urged in the direction of the earphone adaptor body 36. In the supporting substrate 47, there is provided a slide rail 47a, which comprises a slot. Moreover, in the slide 48, there is provided a slide rail 48a, which comprises a slot. Then, by passing a bolt 51 through both slide rails 47a, 48a and securing it with a nut 52, the slide 48 is slidably attached to the supporting substrate 47 in a state in which the slide rail 47a and slide rail 48a are partially overlapping.

When the slide 48 is slid along the supporting substrate 47, the nut 52 is loosened, the slide 48 is slid until reaching the desired length, whereupon the slide 48 is secured in place by fastening the nut 52 again. As a result, the earphone adaptor can be utilized with TV sets of various sizes without making the length of the supporting substrate longer than a predetermined length, as explained in the above-described Embodiment 1. Moreover, when the earphone adaptor is stored, compact storage can be accomplished.

It should be noted that although the earphone adaptor of the present embodiment uses a slide structure in which only the length of the supporting substrate can be adjusted, an adjustable-length slide structure can also be used for the arm and the clamp portion explained in the above-described Embodiment 1. For instance, in the earphone adaptor illustrated in FIG. 9A, furthermore, the proximal end portion of a slide 54 is rotatably coupled to the slide 48 and the arm 49 is slidably attached to the slide 54. Moreover, in the earphone adaptor illustrated in FIG. 9B, the shaft 31 of the clamp portion 29 is supported on the supporting substrate 30 via a slide 53. The slide structure of FIG. 9A in which the arm 49 is extended and retracted, as well as the slide structure of FIG. 9B in which the clamp portion 29 is extended and retracted, are of the same configuration as described above, and their further explanations are omitted.

### Embodiment 4

FIG. 10 is a side view illustrating the relationship between a TV set and an exemplary earphone adaptor in Embodiment 4 of the present invention and FIG. 11 is a schematic rear view of a TV set, to which the earphone adaptor body of the present embodiment is to be secured.

As shown in FIG. 10, the earphone adaptor 54 used in the present embodiment comprises an earphone adaptor body 55 and a securing mechanism 57 securing the earphone adaptor body 55 to a TV set 56. The earphone adaptor body 55 is constituted by a jack carrier 62 supporting a jack 61 into which an earphone plug is plugged, a plug carrier 60 supporting a plug 59 that can be plugged into an earphone jack 58 of the TV set 56, and an electrical cord 63 connecting the jack carrier 62 and plug carrier 60. Moreover, the securing mechanism 57 is constituted by a flexible belt 65 serving as a coupling member, which has one end thereof secured to the electrical cord 63 of the earphone adaptor body 55 and has an annular detent portion 64 provided at the other end. The earphone adaptor body 55 is then secured to the TV set 56 by threadedly securing the detent portion 64 at the other end of the belt 65 to the TV set 56 using an existing screw 67 (see FIG. 11) attached to the rear face of the TV set 56 in a state wherein the plug 59 is plugged into the earphone jack 58 of the TV set 56. In such a case, the length of the belt 65 is set so as to prevent it from slacking when the detent portion 64 of said belt 65 is threadedly secured. It should be noted that if the belt 65 uses, for instance, an extensible configuration utilizing an adjuster provided with a locking mechanism, it becomes possible easily to accommodate variations in the position of the screw 67. Moreover, the detent portion 64 at the other end of the belt 65 can be secured threadedly to the TV set 56 using screws 100, which conform to VESA specifications and are used for attaching the arms of a stand to an LCD TV set.

According to the configuration of the earphone adaptor 54 of the present embodiment, the following effects are obtained because the earphone adaptor body 55 is secured to the TV set 56 by securing, to the TV set 56, the other end of the belt 65 secured to the electrical cord 63 connecting the plug carrier 60 supporting the plug 59 that can be plugged into the earphone jack 58 of the TV set 56 and the jack carrier 62 supporting the jack 61, into which the earphone plug is plugged. Namely, because the jack carrier 62 is pulled towards the TV set 56 through the medium of the electrical cord 63 and the belt 65, even if the earphone plug is pulled at for one reason or another, such as the earphone cord getting caught on a person or an object, or the viewer changing their posture, etc., the force applied to the plug carrier 60 can be reduced. For this reason, the plug 59 of the plug carrier 60 of the earphone adaptor body 55 will not be withdrawn from the earphone jack 58 of the TV set 56 as a result of the earphone plug falling out of the jack 61 of the earphone adaptor body 55 and sudden output of sound from the loudspeakers of the TV set 56 due to the withdrawal of the earphone plug can be prevented.

It should be noted that although in the present embodiment the securing mechanism has been explained by citing an example, in which the securing mechanism 57 is constituted by the belt 65, which has one end thereof secured to the electrical cord 63 of the earphone adaptor body 55 and has the annular detent portion 64 provided at the other end, the earphone adaptor body 55 may be secured to the TV set 56 with the help of a belt 69 having a hook portion 68 provided at the other end, such as, for instance, the one shown in FIG. 12, by engaging the hook portion 68 in a slit 70 (see FIG. 11) provided in the rear face of the TV set 56. Moreover, for instance, the configuration illustrated in FIG. 13 can be utilized as well. Namely, the securing mechanism can also be constituted by a flexible tie member 105 serving as a coupling member, which has one end thereof secured to the electrical cord 63 of the earphone adaptor body 55 and which has an engaging portion 104 provided midway therealong. In such a case, the tie member 105 has a structure including of multiple coupled substantially spherical locking members 103, and the engaging portion 104 has a through-hole 104a, which allows the locking members 103 to pass therethrough, and a slit 104b, which is provided in communication with the through-hole 104a and serves as a withdrawal preventing hole that prevents the withdrawal of the locking members 103. Then, in a state, wherein the tie member 105 is engaged with the antenna terminal 106 (see FIG. 11) provided on the rear face of the TV set 56, the earphone adaptor body 55 can be secured to the TV set 56 by passing the tie member 105 through the through-hole 104a in the engaging portion 104 and slipping it into the slit 104b of the engaging portion 104. Moreover, the invention is not limited to this configuration, any configuration is possible so long as it has configuration an engaging portion capable of locking said coupling member midway through the coupling member. In addition, the coupling member that constitutes the securing mechanism does not necessarily have to have one end thereof secured to the electrical cord 63 of the earphone adaptor body 55, and the electrical cord 63 may be secured to the coupling member midway therealong. The methods used in such cases include any securement methods, such as tying etc.

### Embodiment 5

FIG. 14 is a side view illustrating the relationship between a TV set and an exemplary earphone adaptor in Embodiment 5 of the present invention.

As shown in FIG. 14, the earphone adaptor 71 used in the present embodiment comprises an earphone adaptor body 72 and a securing mechanism securing the earphone adaptor body 72 to the TV set 1. The earphone adaptor body 72 is constituted by a jack 77, into which the earphone plug is plugged, a plug 76, which can be plugged into an earphone jack 2 in the TV set 1, and a jack/plug carrier 101 integrally supporting the jack 77 and plug 76. Moreover, the securing mechanism is constituted by an adhesive layer 78 provided on the end face of the plug 76 (the face that comes into contact with the TV set 1) of the jack/plug carrier 101. Thus, if the plug 76 of the earphone adaptor body 72 is plugged into the earphone jack 2 of the TV set 1, the earphone adaptor body 72 is secured to the TV set 1 with the help of the adhesive layer 78.

In the earphone adaptor 71 of the present embodiment, the jack 77 and plug 76 are supported by the jack/plug carrier 101 in a state in which their central axes are shifted relative to one another. With such a configuration, first of all, the surface area over which the adhesive layer 78 is formed on the end face of the plug 76 of the jack/plug carrier 101 can be increased and, therefore, the bonding strength between the jack/plug carrier 101 and the TV set 1 can be enhanced. Moreover, the distal portion of the jack 77 and the proximal end portion of the plug 76 inside the jack/plug carrier 101 can be made to overlap in the longitudinal direction of the jack/plug carrier 101, and, therefore, the length of the jack/plug carrier 101 in the longitudinal direction can be shortened.

### Embodiment 6

FIG. 15 is a side view illustrating the relationship between a TV set and earphones and an exemplary earphone adaptor in Embodiment 6 of the present invention.

In FIG. 15, the numeral 80 designates a television (TV) set and the numeral 79 designates an earphone jack provided in the TV set 80. The numeral 3 designates earphones and the numeral 4 designates an earphone plug provided in the earphones 3. The earphones 3 and earphone plug 4 are connected via an earphone cord 5.

As shown in FIG. 15, the earphone adaptor 81 used in the present embodiment comprises an earphone adaptor body 82, and a securing mechanism 83 securing the earphone adaptor body 82 to the TV set 80. The earphone adaptor body 82 is constituted by a jack 84, into which the earphone plug 4 of the earphones 3 is plugged, a plug 85 that can be plugged into the earphone jack 79 of the TV set 80, a jack/plug carrier 102 integrally supporting the jack 84 and plug 85, and locking pieces 86 which are locked with the separate securing mechanism 83. On the other hand, the securing mechanism 83 includes a through-hole 87, which allows the plug 85 of the earphone adaptor body 82 to be passed therethrough, locking portions 88, with which the locking pieces 86 of the earphone adaptor body 82 are locked, and an adhesive layer 89 provided on the face that comes into contact with the TV set 80.

The earphone adaptor body 82 is attached to the securing mechanism 83 as a result of the locking pieces 86 being locked with the locking portions 88 of the securing mechanism 83. The location of the locking portions 88 and the locking pieces 86 is adjusted such that when the earphone adaptor body 82 is attached to the securing mechanism 83, the plug 85 of the earphone adaptor body 82 can be plugged into the earphone jack 79 of the TV set 80. In the example shown in FIG. 15, the locking pieces 86 are provided in locations spaced a mm away from the end face on the side of the jack/plug carrier 102 facing the TV set 80, and the locking portions 88 are provided in locations spaced a mm away from the end face on the side of the securing mechanism 83 facing the TV set 80.

The relationship between the securing mechanism and the earphone adaptor body in the present embodiment is shown in FIG. 16. In FIG. 16, the numeral 90 designates guide grooves guiding the locking pieces 86 of the earphone adaptor body 82 into a locked position 91.

As shown in FIG. 16, after being inserted into the locking portions 88 of the securing mechanism 83, the locking pieces 86 of the earphone adaptor body 82 are rotated counterclockwise through 90 degrees and guided into the locked position 91 along the guide groove 90. Although details are not shown in the figure, in the locked position 91, on the bottom face of the guide grooves 90, there is provided a convex protrusion, and the locking pieces 86 are locked in the locked position 91 by surmounting this protrusion. By doing so, the earphone adaptor body 82 is attached to the securing mechanism 83. Conversely, if the jack/plug carrier 102 is gripped and turned clockwise, the locking pieces 86 will be guided by the guide grooves 90 until they reach the locking portions 88 and the locked condition of the locking pieces 86 is released. The earphone adaptor body 82 is then detached from the securing mechanism 83 by pulling the jack/plug carrier 102 away from the securing mechanism 83.

In this manner, only the securing mechanism 83 can be secured to the TV set 80 by making the earphone adaptor body 82 releasably attachable to the securing mechanism 83 through the medium of connecting portions (locking pieces 86 serving as a first connecting portion provided in the earphone adaptor body 82 and locking portions 88 serving as a second connecting portion provided in the securing mechanism 83). Accordingly, when the earphone adaptor body 82 is attached to the securing mechanism 83, the securing mechanism 83 and earphone adaptor body 82 are integrated into a single unit, with the plug 85 of the earphone adaptor body 82 plugged into the earphone jack 79 of the TV set 80.

According to the configuration of the earphone adaptor 81 of the present embodiment, the following effects are obtained. Namely, as a rule, sound output can be obtained from the loudspeakers of the TV set 80 by keeping the earphone adaptor body 82 detached from the securing mechanism 83. On the other hand, when one wishes to stop sound output from the loudspeakers of the TV set 80 late at night or in the early hours of the morning, one can listen to the sound of TV programs etc. via the earphones 3 by attaching the earphone adaptor body 82 to the securing mechanism 83 secured to the TV set 80 and then plugging the earphone plug 4 of the earphones 3 into the jack 84 of the earphone adaptor body 82. Thus, even if the earphone plug 4 is pulled at for one reason or another, such as the earphone cord 5 getting caught on a person or an object or the viewer changing their posture, etc., the plug 85 of the earphone adaptor body 82 will not be withdrawn from the earphone jack 79 of the TV set 80 as a result of the earphone plug 4 falling out of the jack 84 of the earphone adaptor body 82. Accordingly, sudden output of sound from the loudspeakers of the TV set 80 due to the withdrawal of the earphone plug 4 can be prevented.

Moreover, according to the configuration of the earphone adaptor 81 of the present embodiment, unlike in the earphone adaptors of the above-described Embodiments 1-5, prevention of sudden output of sound from the loudspeakers of the TV set due to the withdrawal of the earphone plug 4 is made possible by attaching, if necessary, the earphone adaptor body 82, while enabling sound output from the loudspeakers of the TV set.

It should be noted that although in the present embodiment explanations are provided with regard to an example, in which the adhesive layer 89 serves as a means for securing the securing mechanism 83 to the TV set 80, various means explained in the above-described Embodiments 1-5 can be used as a means of securement.

Moreover, although in the present embodiment the earphone adaptor body 82 is attached to the securing mechanism 83 by locking the locking pieces 86 of the earphone adaptor body 82 with the locking portions 88 of the securing mechanism 83, with regard to means for attaching the earphone adaptor body 82 to the securing mechanism 83, any releasably attachable means for both can be used.

As an example, let us consider the configuration depicted in FIG. 17. In FIG. 17, the numeral 91 designates an earphone adaptor body and the numeral 92 designates a securing mechanism securing the earphone adaptor body 91 to the TV set 80. As shown in FIG. 17, around the periphery of the jack/plug carrier 102, there is provided a stopper portion 94, which restricts the movement of a barrel portion 93, with the barrel portion 93, which has a screw thread 95 serving as a first connecting portion cut on the inside thereof, engaged with the stopper portion 94 from the outside. On the other hand, a screw thread 96, which serves as a second connecting portion, is cut on the outside of the securing mechanism 92. The earphone adaptor body 91 is then attached to the securing mechanism 92 as a result of the screw thread 95 on the inside of the barrel portion 93 of the earphone adaptor body 91 being threadedly secured (engaged) to the screw thread 96 on the outside of the securing mechanism 92. In the same manner as described above, the securing mechanism 92 is secured to the TV set 80 using the adhesive layer 89.

When the earphone adaptor body 91 is attached to the securing mechanism 92, by joining the barrel portion 93 provided on the outside of the jack/plug carrier 102 with the securing mechanism 92 and rotating them, the two are threadedly secured to each other. In such a case, as the barrel portion 93 is threaded in place, the plug 85, which is pushed towards the TV set 80 by the stopper portion 94, is gradually plugged into the earphone jack 79 of the TV set 80 via the through-hole 87 of the securing mechanism 92. When detaching the earphone adaptor body 91 from the securing mechanism 92, it can be removed by rotating the barrel portion 93 in the opposite direction.

Although the above-described Embodiments 1-6 explained examples in which the earphone adaptor was applied to a TV set, in particular, a thin-shaped TV set, the earphone adaptor of the present invention can be used with other audio devices as well. For instance, the earphone adaptor of the present invention can be effectively used with audio devices such as AM/FM radios, CD players, semiconductor memory-based audio devices, etc., as well as with video/audio devices such as portable DVD players, PCs, etc. Then, for instance, when one enjoys a video by connecting earphones to a portable DVD player while traveling on a Shinkansen bullet train, the use of the earphone adaptor of the present invention makes it possible to prevent sound from spilling into the carriage when the earphone plug is withdrawn.

In particular, when the audio devices are equipped with loudspeakers and sound output from the loudspeakers is adapted to stop when an earphone plug is connected, the present invention provides tremendous effects. However, even if the earphone adaptor of the present invention is used with audio devices that are not equipped with loudspeakers, the earphone plug cannot be withdrawn easily, and failures of the audio device can be reduced.

Moreover, although the above-described Embodiments 1-6 mentioned only an “earphone plug”, there exist various types of plugs, depending on the specifications, such as stereo mini plugs, flat connectors, etc., that can be used as earphone plugs. Moreover, there are audio devices, wherein a separate jack for transmitting actuation signals other than audio signals is juxtaposed adjacent to the earphone jack, and these multiple jacks are adapted to be connected using a single earphone cord. In such a case, it is a common practice to display information on the operating status etc. of the device and provide an operating panel for operating the device in the middle portion of the earphone cord. The effects of the present invention can be achieved regardless of the type of the earphone plug. However, when a flat connector and a separate jack for transmitting actuation signals other than audio signals are juxtaposed adjacent to the earphone jack, and these multiple jacks are adapted to be connected using a single earphone cord, it becomes more difficult to withdraw the earphone plug than when there is a standalone earphone jack only. The higher the number of contact points, the more resistant it is to impact from a given direction. Thus, while the present invention is generally used for video/audio devices provided with loudspeakers, such as TV sets, etc., excellent effects are produced when using 3.5 mm mini plugs (both stereo and mono) which are easily withdrawn since they are used as a standalone plug intended only for the transmission of audio signals.

Moreover, the above-described Embodiments 1-6 mentioned only “earphones”, the different names, such as headphones, headsets, etc., all refer to a type of earphones.

Moreover, although explanations in the above-described Embodiments 1-6 were focused on the earphone adaptor, the invention may be adapted to audio devices equipped with jacks for plugging in the earphone plugs of earphones.

For instance, it may be adapted to an audio device with a jack equipped with loudspeakers and an earphone device securable to the body of the audio device, wherein a socket for an electrical connector for detachably connecting the earphone device is provided in the body of the audio device equipped with jacks. The device is then adapted to stop sound output from the loudspeakers when an earphone device is connected to the electrical connector socket.

Moreover, the earphone device is equipped with a jack, into which an earphone plug of the earphone is plugged, an electrical connector plug connectable to the electrical connector socket, and a securing mechanism securing the earphone device to the body of the audio device in a state, wherein the electrical connector plug is connected to the electrical connector socket.

The above-described configuration makes it possible to realize an audio device that produces the same effects as the ones explained in the above-described Embodiments 1-6.

Moreover, it may be adapted to secure the earphone device to the audio device main body on a constant basis, and, using a switch provided in the body of the audio device or the earphone device, adapted to enable the switching (ON/OFF) of the electrical connection between the earphone device and the audio device main body as desired. With such a configuration, when the switch is turned ON, sound output from the loudspeakers is turned OFF and can be listened to via the earphones by plugging the earphone plug of the earphones into the jack of the earphone device. In such a case, even if the earphone plug is withdrawn from the jack of the earphone device, sound will not come from the loudspeakers. On the other hand, when the switch is turned OFF, sound from the loudspeakers will be outputted as usual.

Turning the electrical connection between the earphone device and the audio device main body ON/OFF can be accomplished using an ordinary power ON/OFF switch.

### INDUSTRIAL APPLICABILITY

Thus, the earphone adaptor of the present invention makes it possible to prevent sudden output of sound from the loudspeakers of an audio device due to the withdrawal of an earphone plug. Therefore, the present invention is useful, for instance, as an earphone adaptor for TV sets in shared hospital rooms.

1. An earphone adaptor comprising:
an earphone adaptor body having a jack, into which an earphone plug of earphones is plugged, and a plug that can be plugged into an earphone jack in an audio device; and
a securing mechanism securing the earphone adaptor body to the audio device in a state where the plug is plugged into the earphone jack of the audio device.

2. The earphone adaptor according to claim 1, wherein:
the earphone adaptor body comprises a jack carrier supporting the jack, a plug carrier supporting the plug, and an electrical cord connecting the jack carrier to the plug carrier, and
the securing mechanism is constituted by a flexible coupling member coupling the electrical cord to the audio device.

3. The earphone adaptor according to claim 2, wherein the coupling member has an annular detent portion.

4. The earphone adaptor according to claim 2, wherein the coupling member has a hook portion.

5. The earphone adaptor according to claim 2, wherein the coupling member has an engaging portion that is capable of locking the coupling member and is provided midway therealong.

6. The earphone adaptor according to claim 5, wherein:
the coupling member has a structure of multiple coupled substantially spherical locking members, and
the engaging portion has a through hole, which allows the locking members to pass therethrough, and a withdrawal-preventing hole, which prevents the withdrawal of the locking members and is provided in communication with the through-hole.

7. The earphone adaptor according to claim 1, wherein the earphone adaptor body comprises a jack/plug carrier integrally supporting the jack and the plug.

8. The earphone adaptor according to claim 7, wherein the jack and the plug are supported by the jack/plug carrier in a state in which their central axes are shifted relative to one another.

9. The earphone adaptor according to claim 1, wherein the securing mechanism has a threaded bore permitting threaded securement to the audio device.

10. The earphone adaptor according to claim 1, wherein the securing mechanism has an adhesive layer permitting adhesive securement to the audio device.

11. The earphone adaptor according to claim 1, wherein the securing mechanism has an arm urged in the direction of the earphone adaptor body and a support portion supporting the arm.

12. The earphone adaptor according to claim 11, wherein the arm and/or support portion have an adjustable-length slide structure.

13. The earphone adaptor according to claim 1, wherein the securing mechanism has an adjustable-height clamp portion and a support portion supporting the clamp portion.

14. The earphone adaptor according to claim 13, wherein the clamp portion and/or support portion have an adjustable-length slide structure.

15. The earphone adaptor according to claim 1, wherein the jack is provided so as to be rotatable within a two-dimensional plane as viewed from the front of the earphone jack of the audio device when the earphone adaptor body is secured to the audio device.

16. The earphone adaptor according to claim 1, wherein the jack is provided so as to be rotatable within a plane disposed at right angles to the two-dimensional plane seen from the front of the earphone jack of the audio device when the earphone adaptor body is secured to the audio device.

17. The earphone adaptor according to claim 1, wherein the earphone adaptor body is provided so as to be releasably attachable to the securing mechanism via a connecting portion.

18. The earphone adaptor according to claim 17, wherein the connecting portion is constituted by a first connecting portion provided in the earphone adaptor body and a second connecting portion provided in the securing mechanism, and the earphone adaptor body is attached to the securing mechanism by connecting the first connecting portion and second connecting portion to each other.
